(19) United States
(12) Patent Application Publication
(10) Pub. No.: US 2024/0289683 A1
(43) Pub. Date: Aug. 29, 2024

(54) SELF-SUPERVISED TERM ENCODING WITH CONFIDENCE ESTIMATION

(71) Applicant: International Business Machines Corporation, Armonk, NY (US)

(72) Inventors: Francesco Fusco, Zurich (CH); Diego Matteo Antognini, Ruvigliana (CH)

(21) Appl. No.: 18/175,601

(22) Filed: Feb. 28, 2023

(51) Int. Cl. G06N 20/00

(52) U.S. Cl. CPC G06N 20/00

(57) ABSTRACT

According to one embodiment, a method and computer program product for generating a model including a term encoder is provided. The embodiment may include training the model on a training dataset that associates training terms with first embeddings of the training terms. The training includes generating, with the term encoder, second embeddings from numerical representations of word subunits of the training terms with an objective of minimizing distances between the first embeddings and the second embeddings. The word subunits form part of a predetermined set of word subunits. The training includes predicting confidence scores based on the minimized distances. The embodiment may include deploying the model as part of an executable algorithm to allow a user to infer third embeddings and corresponding confidence scores from any input terms written based on word subunits of the predetermined set.

### BACKGROUND

The invention relates in general to the field of natural language processing (NLP) techniques and, in particular, word embedding techniques. It is notably directed to computer-implemented methods and computer program products relying on models trained on a training dataset that associates training terms with first embeddings. The models are trained to learn to: (i) generate second embeddings from numerical representations of word subunits (e.g., characters) of the training terms with the objective of minimizing distances between the first and second embeddings; and (ii) predict confidence scores based on the minimized distances. Such models can then be deployed to generate term embeddings on-the-fly, something that can for instance be exploited to update large term embedding matrices or compress them.

Large pre-trained language models are extensively used in modern NLP systems. Nevertheless, static embeddings are still an important building block for industrial-grade NLP applications. Word embeddings refer to numerical representations of words. Word embeddings usually consist of numerical arrays of fixed dimensions, normally vectors of N components, where N is typically on the order of hundreds or thousands.

Entity names such as company names, people, chemical elements, or other technical terms, can be suitably embedded using large corpora and algorithms to train static embeddings, such as the so-called word2vec and GloVe algorithms. Static embedding methods typically result in embedding matrices that associate an embedding vector to a respective word or term of a fixed-size vocabulary V. In particular, static embedding algorithms can be used to create high-quality embedding vectors for multiword expressions such as “support vector machine” or “International Business Machines Corporation”. In large industrial applications, where entity names are embedded in addition to single-word tokens, embedding matrices can easily include tens of millions of distinct entries and reach tens of gigabytes in size.

Now, despite the large size of such matrices, the out-of-vocabulary (OOV) problem can still occur. I.e., OOV terms are terms that are not part of the base vocabulary. Contrary to language models or n-gram-based models, term embedding matrices cannot convert OOV terms into respective embeddings. Rather, previously unseen terms are typically converted into a same predetermined vector.

Contextual embedding methods such as the so-called Elmo embedding method or sentence encoders based on the BERT model can be used to extract dense representations for text. Such methods do not require large pre-trained matrices representing large vocabularies; they rely on tokenization to provide representations for text not seen at training time. Unfortunately, sentence encoders do typically not allow a satisfactory quality of representation to be achieved for named entities and technical terms. The problem is especially pronounced for terms drawn from text containing a large number of named entities (e.g., titles for financial news) or technical terms as in scientific literature.

### SUMMARY

According to a first aspect, the present invention is embodied as a computer-implemented method of generating a model that includes a term encoder. Overall, the method revolves around training the model and then deploying the trained model. In detail, the model is trained on a training dataset, which associates training terms with first embeddings of the training terms. The model is trained to learn to generate second embeddings and predict confidence scores. I.e., the first embeddings serve as labels for the model to learn to accordingly generate the second embeddings, where such embeddings are compressed, numerical representations of the words. More precisely, the term encoder learns to generate the second embeddings from numerical representations of word subunits (e.g., characters) of the training terms with an objective of minimizing distances between the first embeddings and the second embeddings. The word subunits form part of a predetermined set of word subunits. Interestingly, the model further learns to predict confidence scores based on the minimized distances. The trained model is subsequently deployed as part of an executable algorithm to allow a user to infer third embeddings and corresponding confidence scores from any input terms written based on word subunits of the predetermined set.

The above solution allows a dynamic embedding model to be obtained based on initial embeddings. The underlying model can rely on standard artificial neural network architectures. The trained model can accordingly infer embeddings, on-the-fly, also for previously unseen terms, unlike typical static embedding algorithms. By construction, the trained model nevertheless allows the generated embeddings to be semantically relevant, inasmuch as the generated embeddings overlap with word subunits as used in the training terms of the training dataset. I.e., because of the word subunit decomposition used, the resulting embeddings will be meaningful as long as the input terms are written based on word subunits of the predetermined set.

By construction, the proposed method provides a simple solution to the out-of-vocabulary problem of pre-trained embedding matrices. All the more, the above method is drastically more efficient than sentence encoders, in terms of inference latency. Finally, this method allows a confidence score to be obtained, in addition to the embedding itself. Such confidence scores can be used to accept or reject the inferred embeddings, something that can notably be leveraged to update (e.g., compress) embedding matrices. In other words, the predicted confidence scores allow some self-supervision.

In preferred embodiments, the word subunits of the training terms are characters, whereby the model is trained to generate the second embeddings based on numerical representations of characters of the training terms. This, in practice, makes it possible to maximize the overlap between unseen terms and the training terms, hence resulting in more meaningful embeddings, eventually. Moreover, this allows to reduce the size of the underlying set of basic elements, as compared to a decomposition based on other types of word constituents.

Preferably, the training terms are captured as tokens, where at least some of said tokens capture respective sets of multiple words. I.e., each of the sets of multiple words has been tokenized into a respective, single token. This way, the first embeddings may for instance reflect named entities, phrases, or other complex terminologies. The corresponding word combinations increase the size of the training dataset. This, in turn, improves the potential overlaps (in terms of word subunits such as characters) between previously unseen terms and the training terms, which eventually benefits to the inference quality.

In embodiments, the method further comprises, prior to training the model, obtaining the training dataset as an embedding matrix mapping the tokens to the first embeddings. Preferably, the method further comprises, prior to obtaining the embedding matrix, running a natural language preprocessing pipeline on text data of one or more text corpora to tokenize the text data. The tokenization process may advantageously involve a sequence tagging model designed to identify named entities, so as to tokenize multiple words corresponding to the name entities into single tokens.

In embodiments, the term encoder includes a word subunit decomposition layer, a word subunit embedding layer, and one or more trainable layers, wherein the word subunit decomposition layer is connected to the word subunit embedding layer, itself connected to the one or more trainable layers. With this architecture in mind, the model is trained by: identifying the word subunits of the training terms through the word subunit decomposition layer; obtaining numerical representations of the identified word subunits through the word subunit embedding layer; and training the one or more trainable layers for them to learn to generate the second embeddings from the obtained numerical representations in accordance with an objective function defining said objective.

Preferably, the one or more trainable layers include several layers that are configured as a multilayer perceptron. In embodiments, the trainable layers further include at least one long short-term memory layer interfacing the word subunit embedding layer with the multilayer perceptron.

In a first class of embodiments, the model further includes an estimator, which is connected by the one or more trainable layers. In this case, training the model further comprises training the estimator for it to learn to predict the confidence scores. Two different objective functions may thus be involved. I.e., said objective function is a first objective function used to train the term encoder, while the estimator is trained to learn to predict the confidence scores in accordance with a second objective function, which defines an objective of minimizing a difference between the confidence scores predicted by the estimator and the first objective function as evaluated based on the minimized distances.

In another class of embodiments, the one or more trainable layers are trained to learn parameters of distributions, from which respective ones of the first embeddings are drawn, whereby the second embeddings and the corresponding confidence scores are obtained from the learned parameters of the distributions.

Preferably, the parameters learned for each of said distributions may include a mean and a variance, where the mean corresponds to a respective one of the second embeddings, while the corresponding confidence score is obtained based on a negative log-likelihood of each distribution. In this case, the objective function may be defined based on negative log-likelihoods of the distributions with respect to the first embeddings.

In embodiments, the objective function used to train the term encoder is designed to define a further objective, in addition to the objective of minimizing said distances. This further objective causes to push the second embeddings towards embeddings of semantically related training terms upon training the model.

Another aspect of the invention concerns inferences performed with the trained model. That is, the present invention can also be embodied as a computer-implemented method of inferring embeddings and corresponding confidence scores with a model including a term encoder. This further method comprises loading a model that has been trained as described above, prior to executing the loaded model on input terms written based on word subunits of the predetermined set to infer third embeddings and corresponding confidence scores.

The inferred embeddings can then be exploited in various ways, in accordance with the corresponding confidence scores, as in preferred applications. Basically, such applications will typically amount to accepting or rejecting the third embeddings based on the corresponding confidence scores, as in preferred embodiments.

In particular, the inferred embeddings and confidence scores can be exploited to update an underlying embedding matrix. For example, assume that the model is executed on a set of terms corresponding to entries of a pre-trained embedding matrix to infer third embeddings and corresponding confidence scores for this set of terms. Then, a lossy compression of the pre-trained embedding matrix can be achieved by pruning entries of the embedding matrix in accordance with the confidence scores inferred for embeddings obtained from this set of terms. As a result, least some of the matrix entries are deleted. Still, the corresponding embeddings can safely be regenerated on-the-fly, thanks to the trained model, if necessary.

In other embodiments, the trained model is used to update an embedding matrix based on new entries thereof. More precisely, the method further comprises accessing additional words of an updated version of a vocabulary, wherein said additional words are not present in the initial version of the vocabulary. In this case, the model is executed on the additional words to controllably update entries of an embedding matrix in accordance with confidence scores inferred for the embeddings generated for the additional words.

Additional aspect of the invention concern computer program products, starting with a computer program product for generating a model including a term encoder, consistently with the first aspect of the invention. The computer program product comprises a computer readable storage medium having program instructions embodied therewith, where the program instructions are executable by processing means of a computerized system to cause the latter to train the model on a training dataset, for the model to learn to generate second embeddings from numerical representations of word subunits of the training terms and predict confidence scores based on the minimized distances, as evoked earlier in reference to the first aspect of the invention.

Alternatively, or in addition, the computer program product may be designed for inferring embeddings and corresponding confidence scores. In that case, the program instructions are executable to cause to load a model trained as described above and execute the loaded model on input terms to infer embeddings and corresponding confidence scores.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 is a diagram illustrating selected components of a computerized system for training models and accordingly performing inferences, as in embodiments;

FIG. 2 is a flowchart illustrating high-level steps of a method of training and exploiting a term encoder model, according to embodiments;

FIG. 3 is a diagram illustrating how a trained model can be exploited to update an embedding matrix, as in embodiments;

FIGS. 4 and 5 show architectures of two classes of term encoder models, as involved in embodiments; and

FIG. 6 schematically represents a general-purpose computerized system, suited for implementing one or more method steps as involved in embodiments of the invention.

The accompanying drawings show simplified representations of devices or parts thereof, as involved in embodiments. Similar or functionally similar elements in the figures have been allocated the same numeral references, unless otherwise indicated.

Computerized methods and computer program products embodying the present invention will now be described, by way of non-limiting examples.

### DETAILED DESCRIPTION OF EMBODIMENTS OF THE INVENTION

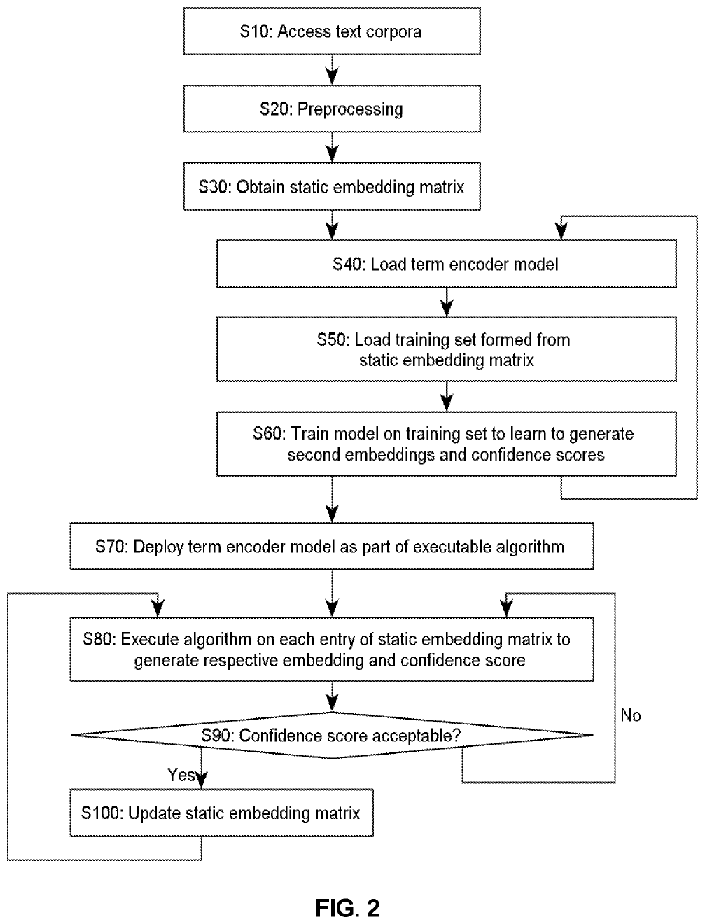

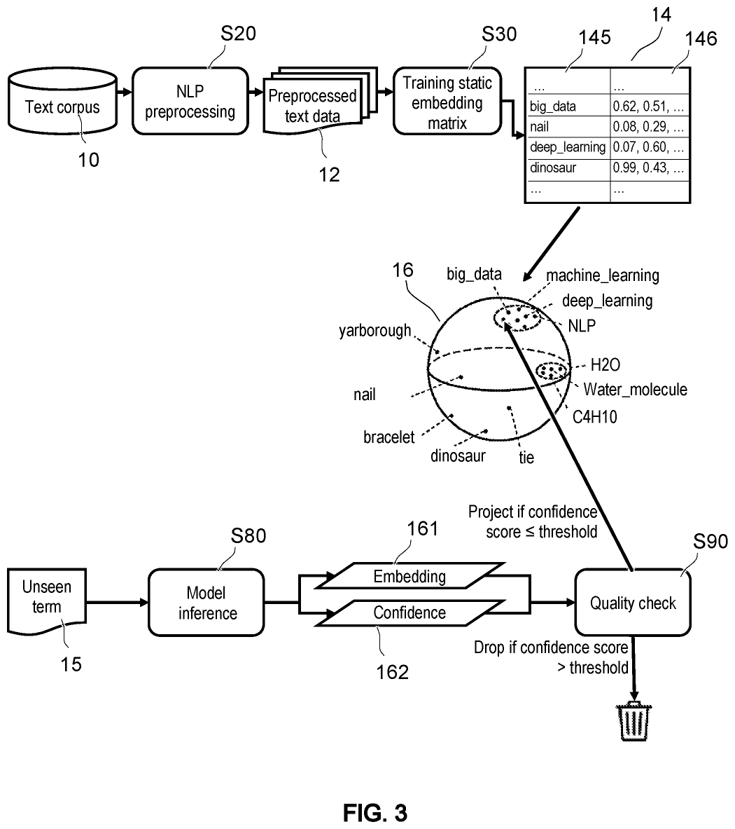

The following description is structured as follows. General embodiments and high-level variants are described in section 1. Section 2 addresses particularly preferred embodiments. Section 3 concerns technical implementation details. Note, the present method and its variants are collectively referred to as the “present methods”. All references Sn refer to methods steps of the flowchart of FIG. 2 (some of these steps are also reflected in the diagram of FIG. 3), while numeral references pertain to devices, components, and concepts, as involved in embodiments of the present invention.

### 1. General Embodiments and High-Level Variants

In reference to FIG. 2, a first aspect of the invention is now described. This aspect concerns a computer-implemented method of generating a model including a term encoder. For this reason, this model is sometimes referred to as a “term encoder model” in the present document.

This method essentially revolves around training the model and then deploying the model, as reflected in step S60 and step S70 of the flowchart of FIG. 2.

The model is trained S60 on a training dataset 14 that associates training terms 145 with respective embeddings 146 of the training terms. In the following, such embeddings are referred to as “first embeddings”. The first embeddings are assumed to have been obtained with any suitable term embedding method, such as a static embedding method. The training dataset may for instance be initially formed S30 as an embedding matrix such as shown in FIG. 3. As further seen in FIG. 3, the training terms much preferably include multiple words, tokenized into single tokens, for reasons discussed later.

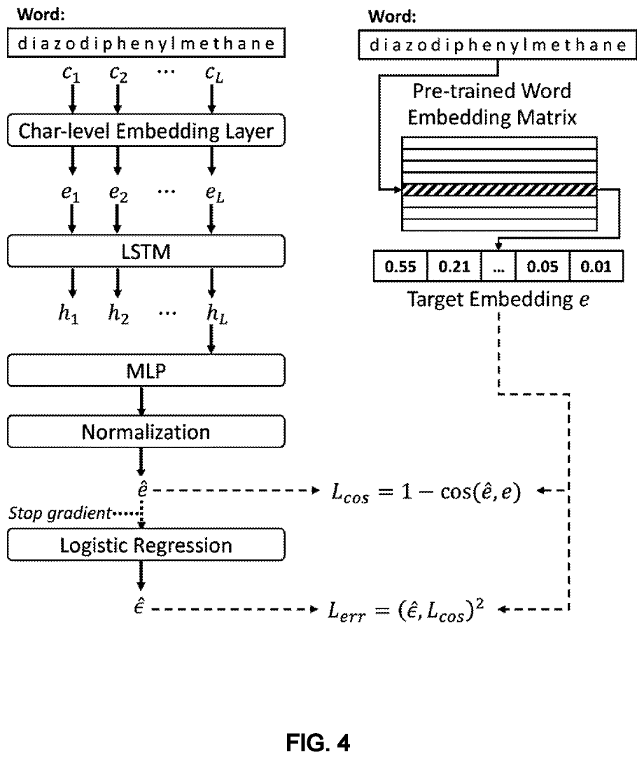

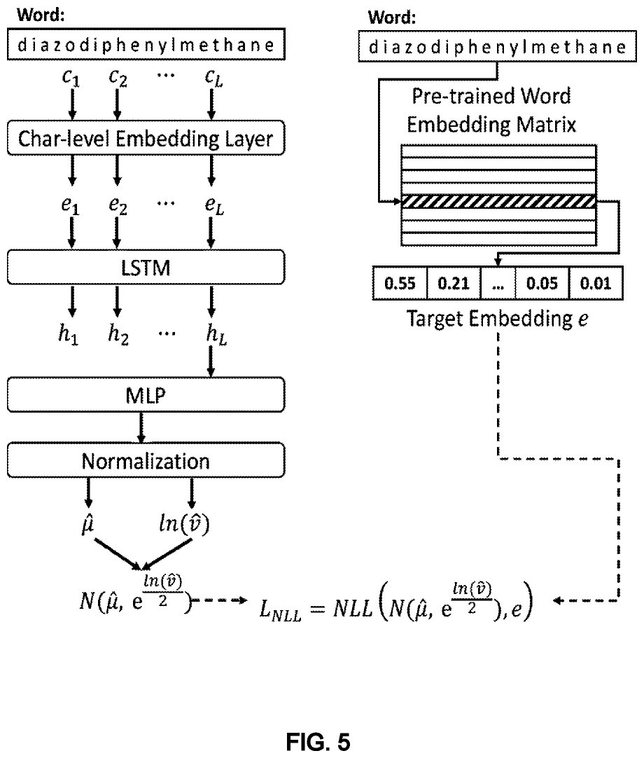

The model is notably trained to learn to generate embeddings (called second embeddings) with the objective of minimizing distances between the first embeddings 146 and the second embeddings. Note, the concept of minimized distance implies that the first embeddings 146 and the second embeddings are same-dimensional arrays (typically vectors) of numbers representing respective training terms 145, so as to make it possible to compute meaningful distances between the arrays. As per this objective, the model learns to reconstruct embeddings that are close to the first embeddings, as also illustrated in FIGS. 4 and 5.

Interestingly, the second embeddings are generated by the term encoder from numerical representations of word subunits of the training terms 145, where the word subunits form part of a predetermined set of word subunits. Here, the word subunits are subword components, i.e., word constituents, which can notably be characters, syllables, or closely related concepts (e.g., moras), morpheme components (e.g., roots and affixes), or any other suitable language subunits having a smaller granularity than the target words. Most efficient, however, is to rely on characters, as in preferred embodiments discussed later in detail.

Moreover, another interesting feature of the proposed method is that the model is further trained to predict confidence scores for the second embeddings, based on the minimized distances. That is, not only the model makes it possible to infer embeddings but, in addition, the model predicts a confidence score for any embedding inferred. Being able to predict such confidence scores is key to applications as contemplated herein.

The trained model is subsequently deployed S70 as part of an executable algorithm, with a view to allowing a user 4 to infer S80 further embeddings 161 (called third embeddings) and corresponding confidence scores 162. By construction, the deployed model allows third embeddings to be inferred S80 from any input term 15, whether previously unseen or not. Because of the word subunit decomposition used, the resulting embeddings will be meaningful as long as the input terms 15 are written based on word subunits of the predetermined set.

Comments are in order. First, according to the above terminologies, the first embeddings correspond to target embeddings, which are used to train the model. The second embeddings are embeddings that are reconstructed during the training phase, i.e., embeddings as formulated during the forward pass. The third embeddings are embeddings generated at a later stage, during the inference phase.

The model trained is a cognitive model, which includes a term encoder. The latter generates embeddings and may further be used to generate confidence scores, as in embodiments. That is, the encoder may output additional data that are used to predict the confidence scores. Alternatively, the model may additionally include an estimator, on top of the encoder, where the estimator is trained to generate confidence scores, as in other embodiments.

The term encoder is basically a text encoder (also referred to as a string encoder) and can be regarded as a specific type of feature extractor. The term encoder is trained in a supervised manner, using input data-label pairs consisting of training terms (the input data) and the corresponding target embeddings (the corresponding labels), here referred to as the first embeddings. Once deployed, the algorithm works by inferencing embeddings from input text (i.e., strings). This makes it possible for users to generate embeddings and corresponding scores from previously unseen terms (i.e., words or sets of words), which do not belong to the training dataset 14. Alternatively, the model may also be run on the same training dataset or another dataset with a view to updating this dataset, i.e., to perform a lossy compression of this dataset or easily update this dataset for new entries, as in embodiments discussed later.

The proposed solution allows a dynamic embedding model to be obtained based on initial embeddings. The trained model can accordingly infer embeddings, on-the-fly, also for previously unseen terms, unlike typical static embedding algorithms. By construction, the trained model nevertheless allows the generated embeddings to be semantically relevant, inasmuch as the generated embeddings overlap with word subunits as used in the training terms of the training dataset 14. Moreover, while the objective used effectively pushes the generated embeddings toward the initial embeddings upon training the model, this objective may possibly be augmented with an additional objective ensuring relevant words representations in contexts, as in embodiments discussed below.

In general, the present models can be implemented using standard neural network architectures. By construction, the proposed method provides a simple solution to the out-of-vocabulary problem of pre-trained embedding matrices. All the more, this method is drastically more efficient than sentence encoders, in terms of inference latency. Finally, the proposed approach allows a confidence score to be obtained, in addition to the embedding itself, something than can be leveraged to update (e.g., compress) embedding matrices, as in embodiments discussed herein. Owing to the confidence scores predicted, the model can be regarded as a self-supervised term encoder model.

All this is now described in detail, in reference to particular embodiments of the invention. To start with, the word subunits considered are preferably characters, as noted earlier. In that case, the model is trained S60 to infer the second embeddings based on numerical representations of characters of the training terms. This, in practice, makes it possible to maximize the overlap between unseen terms and the training terms, hence resulting in more meaningful embeddings, eventually. Moreover, this allows to reduce the size of the underlying set of basic elements, as compared to a decomposition based on other types of word constituents. For instance, there are about 100,000 possible syllables in English language, which must be compared to 26 letters in the English alphabet. Of course, the training and input terms will typically include additional characters, such as digits and other symbols. The characters used may for instance be the 95 printable ASCII characters or a useful subset of the unicode characters, e.g., including at least basic Latin characters, as well as one or more additional sets, such as Latin-1 Supplement, Latin Extended-A to G, spacing modifier letters, phonetic extensions, combining marks (i.e., combining characters), unicode symbols, general punctuation, superscripts and subscripts, currency symbols, letter-like symbols, number forms, mathematical symbols and other technical symbols, etc.

In practice, the training terms 145 are captured as tokens. Each token corresponds to one or more words. Some of the tokens may capture respective sets of multiple words. That is, each set of multiple words (e.g., “supervised learning”) is tokenized into a respective, single token (e.g., “supervised_learning”). So, the training set may advantageously include multiword expressions. So, the terminology “terms” as used in “training terms” and “input terms” is to be understood in a broad sense. Such terms can be any separable word, or group of separable words, phrase, including technical terms (scientific terminologies such as chemical terminologies), zip codes, entity names, phone numbers, etc. Accordingly, some of the tokens of the training set may correspond to multiple words, or combinations of words, digits, and/or other signs, which have been tokenized into single tokens.

For example, the terminologies “machine learning” and “San Francisco” may advantageously be tokenized into “machine_learning” and “san_francisco” instead of, or in addition to, two separate tokens (i.e., “machine”+“leaning” and “san”+“francisco”). The advantages of using first embeddings having entries corresponding to terms, named entities, phrases or other complex terminologies, is that the size of the training dataset (e.g., a static embedding matrix) will be substantially larger than that of training sets based on individual words only. This, in turn, improves the overlap (in terms of word subunits such as characters) between previously unseen terms and the training terms. So, by enlarging the training dataset with multiword tokens, the size of the training data can be substantially increased, which results in increasing the inference quality.

In that respect, and as seen in FIG. 2, the present methods may include a preliminary step of obtaining S30 the training dataset 14 as an embedding matrix 14 mapping the tokens 145 to the first embeddings 146. To that aim, a natural language preprocessing pipeline may initially be run S20 on text data of one or more text corpora to tokenize the text data. One may for example use a static embedding algorithm to obtain S30 the training set. E.g., one may train high-quality embeddings for tokens using static embedding algorithms such as word2vec or GloVe. Use can advantageously be made of a sequence tagging model designed to identify named entities, so as to tokenize multiple words corresponding to such name entities into single tokens. As a result, at least some of the tokens of the training set 14 correspond to multiple words. The latter are tokenized into single tokens, thanks to the sequence tagging model. The latter can notably be designed to recognize named entities such as cities, proper names, companies, products, or domain-specific terminologies, as well as compound words. In general, a sequence tagging model will be able to group individual words, which together have a special meaning. For completeness, the natural language preprocessing pipeline may include additional modules to clean and normalize the text data, prior to tokenizing the data.

The following discusses aspects related to preferred neural network architectures of the present models. In general, such models can be implemented with standard network architectures, e.g., based on long short-term memory (LSTM), gated recurrent units (GRUs), convolutional neural networks (CNNs), and/or transformers. As illustrated in FIGS. 4 and 5, the term encoder may include a word subunit decomposition layer, a word subunit embedding layer, and one or more trainable layers. The word subunit decomposition layer is connected to the word subunit embedding layer, itself connected to the one or more trainable layers. In the examples of FIGS. 4 and 5, the word subunits are assumed to be characters, as also assumed in the following, for the sake of illustration. Thus, in FIGS. 4 and 5, the word subunit decomposition layer is a character decomposition layer, while the word subunit embedding layer is a character embedding layer.

Using such a network architecture, the model is trained S60 by identifying the characters of the training terms 145 through the character decomposition layer. Next, the character embedding layer converts the identified characters into numerical representations. Finally, the trainable layers are trained to learn to generate the second embeddings from the obtained numerical representations in accordance with an objective function, which defines the objective of minimizing distances between the first and second embeddings. In practice, the training operates by optimizing the objective function, which may be defined as, e.g., a loss function, a reward function, or the likes. Thus, the objective function may have to be minimized, maximized, or otherwise optimized (this depending on its exact definition) in respect of the training dataset 14.

The second embeddings are preferably obtained as normalized vectors (i.e., one-dimensional arrays of numbers, having a unit norm). Such vectors are generated by the trainable layers of the model from the numerical representations inputted by the character embedding layer. During the training phase, the term encoder learns its own parameters by minimizing distances between the second (i.e., reconstructed) embeddings and the first embeddings 146. Equivalently, one may also maximize a similarity between the first and second embeddings, where the similarity S is defined as the converse of a distance D, preferably a normalized distance d, such as the cosine distance. The similarity can for instance be defined as S=1/(1+D) or as S=1−d. For example, the term encoder can be trained to generate embedding vectors that have a close cosine similarity with the first embeddings.

In embodiments, the trainable layers include several layers, which are configured as a multilayer perceptron (noted MLP in FIGS. 4 and 5). Moreover, the trainable layers may advantageously include at least one LSTM layer, arranged so as to interface the character embedding layer with the multilayer perceptron. In the examples of FIGS. 4 and 5, the LSTM layer produces successive outputs h₁-h_{L}, at time steps corresponding here to the successively obtained representations e₁-e_{L} of the successively added characters c₁-c_{L}. I.e., each output hⱼ is produced in response to the successively produced eⱼ. Note, the outputs h₁-h_{L} all have the same dimensions as the embeddings ê as eventually produced by the term encoder. In the examples of FIGS. 4 and 5, only the last output h_{L} is fed to the MLP. In variants, an average of the outputs h₁-h_{L}may be used instead of h_{L}.

In addition, the model typically includes a normalization layer, as assumed in FIGS. 4 and 5. Various other architectures can be contemplated. In general, the present cognitive models can be implemented with standard LSTMs, GRUs, CNNs, and/or transformers.

In a first class of embodiments, the model further includes one or more subsequent layers defining an estimator, to generate the desired confidence score predictions based on the minimized distances, as seen in FIG. 4. In this example, the estimator is connected by the trainable layers (in fact the MLP). In that case, the training involves two stages, one to train the term encoder, and another one to train the estimator for it to learn to predict the confidence scores.

The “stop gradient” seen in FIG. 4 delimits respective portions of the model. The estimator is typically optimized using a second objective function, distinct from the first objective function. The second objective function may for instance define an objective of minimizing a difference between the confidence scores \hat{∈} generated by the estimator and the first objective function as evaluated based on the minimized distances. E.g., while the loss function L_{cos} used as the first objective function may cause to minimize the cosine distance 1−cos (ê, e) between each generated embedding ê and each respective target embedding e, the second objective function may be defined as a loss Lₑᵣᵣ causing to minimize the squares of the distances between each confidence score \hat{∈} and the corresponding cosine distance, as suggested in FIG. 4. Note, with this definition, the confidence score \hat{∈} measures a discrepancy, i.e., an error between the reconstructed embedding and the target embedding. I.e., the larger the score, the lesser the confidence, a priori.

Remarkably, the estimator may consist of a single logistic regression layer. That is, a simple logistic regression can be sufficient to provide a confidence score, making the overall model lightweight and effective. This means that given an embedding vector (a point on the unit sphere 16, see FIG. 3), the estimator outputs a scalar corresponding to the prediction confidence (e.g., normalized to the range [0 to 1]), based on the inferred embedding ê. I.e., \hat{∈} is computed as a logistic function of ê. Beyond regressions, however, other prediction models can more generally be contemplated, calling for a tradeoff between quality of prediction and inference speed.

FIG. 5 illustrates another class of embodiments, where embeddings and corresponding confidence scores are generated from distribution parameters. The network architecture remains generally the same. However, the trainable layers are now trained to learn parameters of distributions, from which respective ones of the first embeddings 146 are drawn. The second embeddings and the corresponding confidence scores are obtained from the learned parameters of the distributions. Various types of parameters can be relied on, depending on the distribution definition. For example, where two-parameter distribution are used, the parameters will typically be the average and the standard deviation (or equivalently the variance). Three-parameter distributions will normally be defined based on the average, standard deviation, and skewness. A fourth parameter can be the kurtosis, and so on. More generally, the distributions may be defined in terms of moments or cumulants, from which the second embeddings and the corresponding confidence scores can be obtained.

Assuming that the distributions are normal distributions, the parameters learned for each distribution include a mean and a variance (or the like). Preferably, one uses the log-variance instead of the variance, to make it easier to reparametrize the gradients upon training the model. In other words, the term encoder can be trained to predict the mean and the log-variance of a distribution (assumed to be normal), from which an initial embedding has been drawn. On inferencing, the mean of a predicted distribution will correspond to the predicted word embedding, while the log-likelihood of the distribution can be used to estimate the quality of the predicted word embedding (i.e., the error).

In practice, the log-likelihood is highly correlated with the quality of the prediction, e.g., the cosine similarity between the generated and the initial embedding. Since each pair of parameters learned defines a respective distribution, the trained model actually predicts a distribution, whose mean corresponds to a word embedding, while the log-likelihood can be used as a proxy to estimate the model's uncertainty. As further suggested in FIG. 5, the objective function may be defined based on negative log-likelihoods of the distributions with respect to the first embeddings 146.

Several variants to FIGS. 4 and 5 can be contemplated. In particular, the two approaches may be combined. For example, the confidence scores may be computed as a combination of the scores obtained in accordance with FIGS. 4 and 5, e.g., as an average of the score of a logistic regression model and the log-likelihood of a distribution from which an embedding is derived.

So far, the term encoder is assumed to be trained in accordance with a single objective, designed to push the second embeddings toward the first embeddings. Now, the objective function may possibly be supplemented with an auxiliary objective, to push the second embeddings towards embeddings of semantically related training terms 145 upon training the model. That is, the objective function used to train the term encoder may be formulated as a dual function. The additional objective makes it more likely that words that are closer in the vector space are also similar in meaning. Note, this additional objective should be distinguished from the additional objective function used for the estimator of FIG. 4.

The above description focused on the training of the term encoder model. Another aspect of the invention is now described in detail, which concerns inferences made with the term encoder model and how such inferences can be exploited for practical purposes. This additional aspect is primarily described in reference to FIGS. 2 and 3. It concerns a computer-implemented method of inferring embeddings and corresponding confidence scores with a model including a term encoder.

To that aim, the method first loads the trained model. The latter is assumed to have been trained in accordance with a method as described earlier in respect of the first aspect of the invention. I.e., this model has been trained on a training dataset 14 associating training terms 145 with first embeddings 146, so as to learn to generate second embeddings and predict corresponding confidence scores. That is, the model is assumed to have learned its own parameters by generating second embeddings from numerical representations of word subunits (preferably characters) of the training terms 145, while additionally predicting corresponding confidence scores. The latter are predicted based on distances as minimized between the first embeddings and the second embeddings, as per the objective function used to train the term encoder. Again, the training terms 145 are preferably assumed to include multiword expressions.

Next, the loaded model is executed S80 on given input terms 15, which are assumed to be written based on word subunits as used in the training terms. The goal is to infer third embeddings 161 and corresponding confidence scores 162, quickly and efficiently, for each input term of interest to the user.

In turn, the method may accept (S90: Yes) or reject (S90: No) the third embeddings 161 based on the corresponding confidence scores 162, as also illustrated in FIG. 3. Note, this step may be performed fully automatically, based on the confidence scores 162 obtained. In variants, this may be subjected to a user approval. In other variants, this process S90 may involve a rewarding process, as in reinforcement learning.

Assume that an inference is performed at step S80 based on a previously unseen input term “semi-supervised learning”, while the training terms included tokens capturing such concepts as “machine learning”, “supervised learning”, and “unsupervised learning”. In that case, the overlap, in terms of word subunits (e.g., characters), between the input term (“semi-supervised learning”) and embeddings as already learned for neighboring terms, will likely results in an embedding that is close to embeddings for the neighboring terms. In addition, the predicted confidence score will likely be low (indicating a small error, a priori). Thus, the quality check performed at step S90 will likely accept the inferred embedding, as assumed in FIG. 2. However, an embedding inferred for a very rare term (e.g., “blatherskite”), not well represented in the training set, may possibly be accompanied by a high score value, which is above an acceptable threshold. In that case, the quality check performed at step S90 will likely reject the inferred embedding. This mechanism is also illustrated in FIG. 3.

Various applications can be contemplated, starting with applications aiming at updating the underlying embedding matrix. That is, the model may be executed S80 on a set of terms corresponding to entries of a pre-trained embedding matrix 14 to infer third embeddings 161 and corresponding confidence scores 162 for this set of terms. Next, a lossy compression of the pre-trained embedding matrix 14 may be performed S80-S100 by pruning entries of the embedding matrix in accordance with the confidence scores inferred. As a result, at least some of the entries of the embedding matrix are deleted S100, in accordance with their respective confidence scores. That is, the present methods can be used as a lossy compressor to selectively keep only those embeddings that cannot be faithfully reproduced by the term encoder. Thus, as illustrated in FIG. 3, the quality check performed at step S90 may decide to solely keep in memory the embeddings for which the projector will introduce an error higher than a given threshold. The embeddings corresponding to the deleted entries can still be re-regenerated on-the-fly, if needed. This approach gives the flexibility to balance between the memory required to store extremely large embedding matrices and the computational efforts required to reproduce the embeddings in a lossy manner.

Further factors may possibly be considered, in addition to the quality of the reconstructed embeddings, starting with the rarity of the terms concerned. E.g., the present methods may maintain statistics as to the training terms or sort the matrix rows in accordance with frequencies at which the corresponding embeddings are used. In turn, this information can be used to reduce the embedding matrix size by deleting those rarely used entries for which the term encoder produces acceptable embeddings.

Apart from lossy compressions, the present methods may also be used to merely update an embedding matrix. For example, the loaded model may be fed with additional words of an updated version of a vocabulary, where these additional words are not present in the initial version of the vocabulary. The latter is assumed to be associated with a given embedding matrix. In that case, executing the model on the additional words makes it possible to controllably update S90-S100 entries of the associated embedding matrix 14, in accordance with confidence scores inferred for the embeddings generated for the additional words. I.e., the model is here used to extend an existing pre-trained matrix with additional entries, in a controlled manner.

Further applications can be contemplated. For example, irrespective of the quality and complexity of the initial embedding algorithm used, the present approach can be used to create simpler embedding models, which are more efficient than pre-trained text encoders as typically used to compute dynamic embeddings. For example, a complex text encoder may be used to produce word embeddings for multiword expressions. This complex text encoder may then be used to produce high-quality embeddings, albeit at a high computational cost. Now, the present approach may judiciously be used to train inexpensive surrogate models for specific lexical fields. That is, one may initially create S30 an embedding matrix subset, the entries of which are actually sampled from a lexical field of interest. Next, using embeddings as initially obtained with the large model, one may train S60 a lightweight, surrogate model, fit to the lexical field of interest.

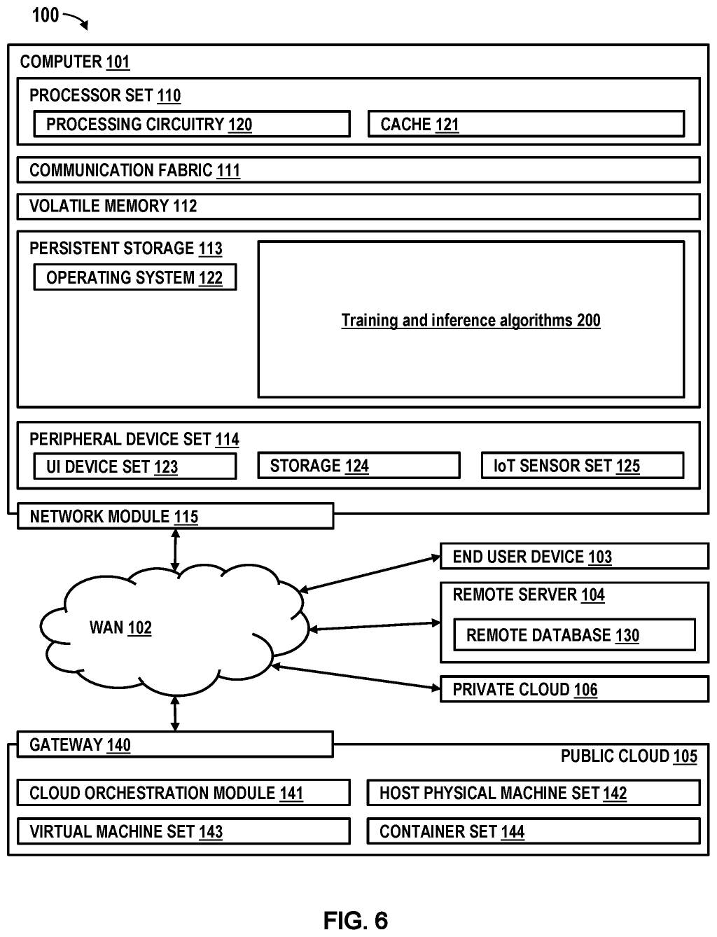

Further aspects of the invention concern computer program products, whether for generating a term encoder model and/or for inferring embeddings and corresponding confidence scores. In both cases, the computer program products comprise a computer readable storage medium having program instructions embodied therewith. Such program instructions are executable by processing means of a computerized system, e.g., a computerized unit 101 such as shown in FIG. 6. In operation, such instructions cause the computerized system to train and deploy the model, as described earlier in respect of the first aspect of the invention. Alternatively, or in addition, such instructions may cause the computerized system to load and execute the model, in accordance with the second aspect of the invention described above. Computer program products are further discussed in Sect. 3.

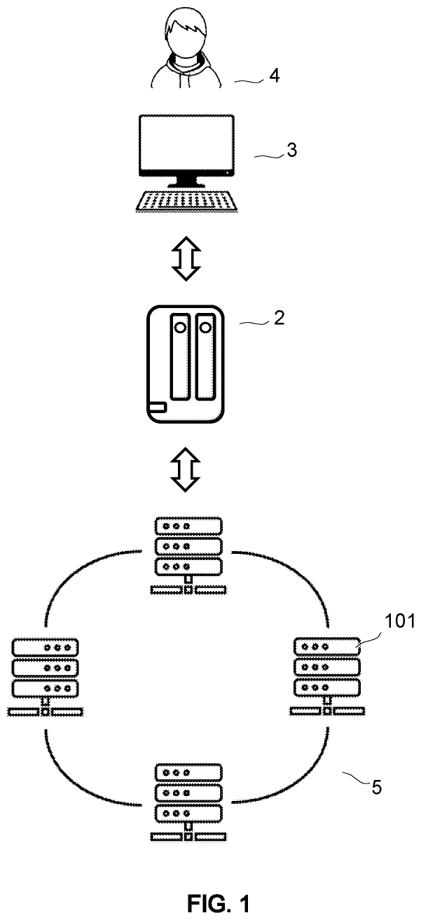

The present methods can, in principle, be implemented on any suitable computerized system. For example, FIG. 1 illustrates a network 5 involving several computers 101 (such as shown in FIG. 6) and a server 2. The server 2 is here assumed to interact with clients 4, who may be natural persons (interacting via personal computers 3), processes, or machines. Each computer 101 is configured to read data from, and write data to, the memory unit of the server computer 2 in this example. Client requests are managed by the server 2, which may notably be configured to assign a given user request to one or more of the computers 101, with a view to training and/or executing a term encoder model, amongst other tasks. The network 5 may notably be configured as a distributed computing system, possibly an edge computing system. Other architectures can be contemplated, involving one or more general-purpose computers. In variants, the computer network 5 may be configured as a composable disaggregated infrastructure, which may further include hardware acceleration devices, e.g., in-memory compute (IMC) devices, application-specific integrated circuits (ASICs), and/or field-programmable gate arrays (FPGAs).

The above embodiments have been succinctly described in reference to the accompanying drawings and may accommodate a number of variants. Several combinations of the above features may be contemplated. Examples are given in the next sections.

### 2. Particularly Preferred Embodiments

### 2.1 Preferred Flow (FIG. 2)

FIG. 2 shows a preferred flow of operations, in which a text corpora 10 is accessed at step S10 and subjected to some standard NLP preprocessing steps S20, to clean and normalize the text data. In addition, single words and multiple word combinations are tokenized S20. Use is made of a sequence tagging model to identify named entities, so as to tokenize multiple words corresponding to name entities into single tokens. An embedding matrix is subsequently formed S30 from the preprocessed text data 12 resulting from step S20. At step S40, the term encoder model (still untrained) is loaded in the main memory of a computerized system. At step S50, a training dataset is formed as input-output pairs from the static embedding matrix, and subsequently loaded in the main memory of the computerized system, the memory permitting. In variants, a stepwise training strategy can be relied on. The model is trained at step S60, so as to learn to generate second embeddings and confidence scores from the training dataset, in accordance with one or more objective functions, as discussed in Sect. 1. The trained model is then deployed at step S70, as part of an executable algorithm.

The deployed model is then executed at step S80, with a view to updating S100 an embedding matrix 14 based on the confidence scores obtained upon performing inferences on input terms of the embedding matrix. The model may for instance be executed on each input term (i.e., each entry) of the same static embedding matrix 14 as used to form the training dataset. The aim is to reconstruct respective embeddings and generate corresponding confidence scores. Next, the embedding matrix is pruned S100 by deleting any entry for which the confidence score is acceptable (S90: Yes). Conversely, entries for which the confidence score is unfavorable should rather be kept (S90: No) in memory.

### 2.2 Diagram of FIG. 3

A similar scheme may be used to update a target embedding matrix, whether related to the initial matrix 14 or not. In the example of FIG. 3, the target matrix is assumed to be the same as the initial embedding matrix 14. The trained model is executed S80 on previously unseen terms 15 to generate respective embeddings 161 and confidence scores 162. The target matrix 14 is then updated S90 in accordance with the confidence scores obtained. I.e., terms and embeddings for which the confidence scores are acceptable are added to the matrix, while other terms are discarded.

In detail, FIG. 3 assumes that a large corpus of raw text 10 is collected and pre-processed S20 using NLP pipelines to perform simple operations such as cleaning, lower-casing, and other normalization operations. Additionally, an information-extraction pipeline is used to recognize named entities, such as locations, people, company, and product names, as well as technical terms. This makes it possible to tokenize multiword expressions, in addition to single words. After preprocessing S20, a static embedding algorithm is used S30 to extract high-quality representations for both single tokens and multiword tokens. An embedding matrix is accordingly obtained S30. While such an embedding matrix may typically contain millions of entries in industrial applications, it will still suffer from the out-of-vocabulary issue, hence the benefit of the proposed approach.

As further illustrated in FIG. 3, inferences are performed S80 on previously unseen terms 15 (i.e., terms not present in the original corpora) to project the resulting embeddings in the embedding space trained over the corpora. That is, given some input text 15, the character-based model is used to infer a vector corresponding to text that best represents this term in the embedding space trained over the corpus. Unlike sentence encoders, the model actually infers S80 both an embedding 161 and a confidence score 162, where the latter allows a simple, yet effective quality assurance of the predicted projection to be performed S90.

Similarly, any downstream system may decide to use the inferred representation or ignore it if the confidence obtained is too low for the downstream task.

### 2.3 Preferred Model Architectures

Suitable character-based models can be trained using different training objectives. A cosine distance is used in the model shown in FIG. 4 (call it the “first model”), while the model (“second model”) of FIG. 5 relies on the negative log-likelihood of the predicted distributions. The main difference resides in the interpretation of the produced outputs and the computation of the quality of the projected embeddings.

The first model predicts a word embedding vector and optimizes the cosine similarity distance between the predicted embedding and the original embeddings (i.e., the word embedding to be learned). Note, one may, in principle, directly optimize against the mean squared error. However, in practice, better results are obtained in terms of cosine similarity. Overall, the encoder shown in FIG. 4 allows a multivariate regression task. Still, this encoder does not permit to estimate the prediction quality on inferencing. This is problematic because it may sometimes be preferable to rely on a predetermined, out-of-vocabulary embedding rather than an inaccurate embedding. Therefore, the first model further includes an estimator to predict the error (i.e., based on the cosine similarity). This estimator involves a logistic regression between the reference and predicted embeddings, using only the predicted embedding as input. To train this estimator, one may for instance minimize the mean square error between the predicted error and the cosine similarity distance from the previous step. A standard gradient descent can be applied for the first objective function (first loss) and for the second objective function (second loss), to stop the gradient propagation at the predicted embedding. A nice property of the above setup is that the error is independently estimated: it can be retrained regularly without retraining the whole model. For example, this approach makes it possible to train one or multiple models to better estimate the error, given the predicted embeddings.

The second model uses a probabilistic interpretation; it predicts the parameters of a normal distribution: the mean and the log-variance. I.e., the second model predicts a distribution from which a target word embedding is drawn. The second model is trained using the negative log-likelihood. On inferencing, the mean of the distribution corresponds to the predicted word embedding, and the log-likelihood reflects the quality of the predicted word embedding (i.e., the error).

In both cases, the predicted error is preferably normalized to the range [0,1] using the minimum and maximum values of the error or the log-likelihood of the samples in the training set. This results in a better understanding of the model's uncertainty and thus, allows better decisions to be made in respect of the predicted embeddings. Overall, the first model was found to provide better results.

### 3. Technical Implementation Details

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Referring to FIG. 6, computing environment 100 contains an example of an environment for the execution of at least some of the computer code involved in performing the inventive methods, such as training, deploying, and performing inferences with the present models 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located off chip. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated.

What is claimed is:

1. A computer-implemented method of generating a model including a term encoder, the method comprising:
training the model on a training dataset that associates training terms with first embeddings of the training terms, wherein the training comprises:
generating, with the term encoder, second embeddings from numerical representations of word subunits of the training terms with an objective of minimizing distances between the first embeddings and the second embeddings, wherein the word subunits form part of a predetermined set of word subunits; and
predicting confidence scores based on the minimized distances; and
deploying the model as part of an executable algorithm to allow a user to infer third embeddings and corresponding confidence scores from any input terms written based on word subunits of the predetermined set.

2. The computer-implemented method according to claim 1, wherein the word subunits of the training terms are characters, and wherein the model is trained to generate the second embeddings based on numerical representations of characters of the training terms.

3. The computer-implemented method according to claim 1, wherein the training terms are captured as tokens, and wherein at least some of the tokens capture respective sets of multiple words, and wherein each of the sets of multiple words are tokenized into a respective single token.

4. The computer-implemented method according to claim 3, further comprising:
prior to training the model, obtaining the training dataset as an embedding matrix which maps the tokens to the first embeddings.

5. The computer-implemented method according to claim 4, further comprising:
prior to obtaining the embedding matrix, running a natural language preprocessing pipeline on text data of one or more text corpora to tokenize the text data using a sequence tagging model designed to identify named entities, so as to tokenize multiple words corresponding to the name entities into single tokens.

6. The computer-implemented method according to claim 1, wherein the term encoder includes a word subunit decomposition layer, a word subunit embedding layer, and one or more trainable layers, and wherein the word subunit decomposition layer is connected to the word subunit embedding layer, itself connected to the one or more trainable layers, and wherein training the model comprises:
identifying the word subunits of the training terms through the word subunit decomposition layer;
obtaining numerical representations of the identified word subunits through the word subunit embedding layer; and
training the one or more trainable layers to generate the second embeddings from the obtained numerical representations in accordance with an objective function defining the objective.

7. The computer-implemented method according to claim 6, wherein the one or more trainable layers include several layers that are configured as a multilayer perceptron.

8. The computer-implemented method according to claim 7, wherein the one or more trainable layers further include at least one long short-term memory layer interfacing the word subunit embedding layer with the multilayer perceptron.

9. The computer-implemented method according to claim 6, wherein the model further includes an estimator connected by the one or more trainable layers, and wherein training the model further comprises training the estimator to predict the confidence scores.

10. The computer-implemented method according to claim 9, wherein the objective function is a first objective function, and wherein the estimator is trained to predict the confidence scores in accordance with a second objective function, the second objective function defining an objective of minimizing a difference between the confidence scores predicted by the estimator and the first objective function as evaluated based on the minimized distances.

11. The computer-implemented method according to claim 6, wherein the one or more trainable layers are trained to learn parameters of distributions, from which respective ones of the first embeddings are drawn, and wherein the second embeddings and the corresponding confidence scores are obtained from the learned parameters of the distributions.

12. The computer-implemented method according to claim 11, wherein the parameters learned for each distribution of the distributions include a mean and a variance, the mean corresponding to a respective one of the second embeddings, while a corresponding one of the confidence scores is obtained based on a negative log-likelihood of the each distribution.

13. The computer-implemented method according to claim 12, wherein the objective function is defined based on negative log-likelihoods of the distributions with respect to the first embeddings.

14. The computer-implemented method according to claim 6, wherein the objective function is designed to define a further objective, in addition to the objective of minimizing said distances, the further objective causing to push the second embeddings towards embeddings of semantically related training terms upon training the model.

15. A computer-implemented method of inferring embeddings and corresponding confidence scores with a model including a term encoder, the method comprising:
loading a model that has been trained on a training dataset associating training terms with first embeddings of the training terms, wherein the loading comprises:
generating, with the term encoder, second embeddings from numerical representations of word subunits of the training terms with an objective of minimizing distances between the first embeddings and the second embeddings, wherein the word subunits form part of a predetermined set of word subunits; and
predicting confidence scores based on the minimized distances; and
executing the loaded model on input terms written based on word subunits of the predetermined set to infer third embeddings and corresponding confidence scores.

16. The computer-implemented method according to claim 15, further comprising:
accepting or rejecting the third embeddings based on the corresponding confidence scores.

17. The computer-implemented method according to claim 15, wherein the model is executed on a set of terms corresponding to entries of a pre-trained embedding matrix to infer third embeddings and corresponding confidence scores for the set of terms, and wherein the computer-implemented method further comprises:
performing a lossy compression of the pre-trained embedding matrix by pruning entries of the pre-trained embedding matrix in accordance with the confidence scores inferred for the set of terms, whereby at least some of the entries are deleted.

18. The computer-implemented method according to claim 15, further comprising:
accessing additional words of an updated version of a vocabulary, wherein the additional words are not present in an initial version of the vocabulary; and
executing the model on the additional words to controllably update entries of an embedding matrix in accordance with confidence scores inferred for the embeddings generated for the additional words.

19. A computer program product for generating a model including a term encoder, the computer program product comprising:
one or more computer-readable tangible storage medium and program instructions stored on at least one of the one or more tangible storage medium, the program instructions executable by a processor capable of performing a method, the method comprising:
training the model on a training dataset that associates training terms with first embeddings of the training terms, wherein the training comprises:
generating, with the term encoder, second embeddings from numerical representations of word subunits of the training terms with an objective of minimizing distances between the first embeddings and the second embeddings, wherein the word subunits form part of a predetermined set of word subunits; and
predicting confidence scores based on the minimized distances.

20. The computer program product of claim 19, wherein the word subunits of the training terms are characters, and wherein the model is trained to generate the second embeddings based on numerical representations of characters of the training terms.
